(19) United States
(12) Patent Application Publication
(10) Pub. No.: US 2026/0311181 A1
(43) Pub. Date: Oct. 8, 2026

(54) SYSTEMS AND METHODS FOR ENHANCING HUMAN-IN-THE-LOOP LABELING PROCESS USING TABURAL EMBEDDING AND LABEL PROPAGATION

(71) Applicant: Capital One Services, LLC, McLean, VA (US)

(72) Inventors: Hongshuang Li, McLean, VA (US); Zhenwei Li, McLean, VA (US); Meera Das, McLean, VA (US); Gang Mei, McLean, VA (US); Kishore Karra, McLean, VA (US); Xirui Hou, McLean, VA (US)

(73) Assignee: Capital One Services, LLC, McLean, VA (US)

(21) Appl. No.: 19/169,965

(22) Filed: Apr. 3, 2025

(51) Int. Cl. G06Q 20/40

(52) U.S. Cl. CPC G06Q 20/4016

(57) ABSTRACT

The disclosure is generally directed to optimizing anti-money laundering (AML) risk detection models using unlabeled tabular transactional data. The disclosure involves a semi-supervised learning technique for generating robust labels for unlabeled data points, which improves utility of such data for training risk models for AML detection. Exemplary implementations involve modifying the raw unlabeled dataset with a small population of labeled data points (e.g., a reference dataset) and adapting a FT-Transform process for mapping the modified raw data (which includes the reference set) into an optimized embedded data space. An iterative label propagation process, starting from the embedded reference dataset, is then used to infer labels for all the data points. A label quality score (e.g., strength of the inference) can also be assigned to each generated label.

### FIELD OF THE DISCLOSURE

The present disclosure is generally related to training data models for risk identification, and more specifically to enhancing human-in-the-loop labeling process for training risk identification models using unlabeled data samples.

### BACKGROUND

Financial institutions are generally required to identify customer activity that may be indicative of potential money laundering or other financial crimes and to report that activity to the government through suspicious activity reports (SARs). Conventional risk identifications models are typically rules-based models. Machine learning (ML) methodologies, such as supervised learning models, may be used for risk modeling, however, a primary challenge in implementation of such learning models is the limited availability of labeled training data, which is critical for all supervised learning models. The existing labeled data used in implementation of supervised learning models is mainly compiled by traditional rule-based risk detection methodologies. For example, a customer transaction activity triggers an alert as determined by a set of rule designations. Once a rule-based model generates an alert in response to an incoming or aggregated transaction activity record, the altered activity record and/or corresponding account/user is investigated and based on a result of the investigation, a label classifying the corresponding transaction record and/or account activity metric as suspicious activity (e.g., risky) or non-issue (e.g., not risky) may be created. Alerted transaction and/or account activity records, for which a target label is created, correspond to above-the-line (ATL) data sample space which may be used for training supervised machine learning models. However, with respect to population of transaction records that have not trigger one or more alert conditions, as prescribed by a rule-based model, no alert and accordingly no label is generated. It is generally assumed that unalerted, and therefore unlabeled, transaction records fall into below-the-line (BTL) sample space that are sufficiently unlikely to be suspicious.

Although the challenge of acquiring human-generated labels for training supervised machine learning models (e.g., for risk detections such as anti-money laundering (AML) associated transactional activities) applies to all fields requiring human labeling, it is particularly prevalent in pockets of data that were deemed historically as low-risk (e.g., unalerted transaction/account activity records). Generally random or stratified sampling has been widely used to pull samples from unlabeled data populations associated with unalerted data domain. Accordingly, there is a need for a better strategy of generating reliable labels for BTL data records that can be generalized across ML models, as well as optimizing the costly human-in the-loop labeling process in terms of performance and cost.

These and other deficiencies exist. As such, there is need for improved systems and methods for enabling automation of accurate label generation that can be used to implement supervised training models with BTL data samples and improve the human-in the-loop labeling process.

### SUMMARY OF THE DISCLOSURE

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

One aspect of the present disclosure is directed to providing a more effective risk coverage using machine learning (ML) models that focuses on predicting the probability of money laundering behavior by using a comprehensive set of variables available within the data, instead of relying on strict parameter threshold values to determine alert criteria. Such a model may be better suited for the detection of outlier behavior that the majority of Anti-Money Laundering (AML) models are designed to detect. A risk identification data model, utilizing machine learning features, enables a comprehensive analysis without end-user bias of what qualifies as “suspicious” with regard to amount values or other historically defined threshold parameters for identifying target data sample (alerted data) corresponding to Above-The-Line (ATL) data (e.g., rule-based alerted data classified as suspicious activity or non-issue by a verifying agent).

One aspect of the present disclosure is related to a system and method for optimizing AML risk detection models using unlabeled tabular transactional data. In some embodiments, the tabular transaction data may comprise a small portion of previously labeled data. In other embodiments, the unlabeled tabular dataset may be enhanced with a small population of reference data (e.g., labeled data records). In accordance with one embodiment of the present disclosure, a semi-supervised learning process may be implemented to convert a partially labeled tabular dataset (e.g., including one or more reference data records) into a fully labeled data set that may be used for training a fully-supervised learning model

A supervised learning model works by learning from a labeled set of data (e.g., one or more reference data points) to make correct decisions. Data labeling typically starts by asking humans to make judgments about a given piece of unlabeled data. “Human labels” in the context of training supervised machine learning models refers to the process where humans manually annotate raw data with descriptive tags or categories, creating labeled datasets that the machine learning model can learn from to make predictions on new data. In a lot of real-world scenarios, we have only a small amount of labeled data and a large pool of unlabeled data. Semi-Supervised Learning (SSL) is adapted to take advantage of those unlabeled samples by leveraging the small amount of labeled data to guide the learning process.

A data point with labeled features but no target value label is considered “unlabeled data” in the context of machine learning; it means the data point has descriptive information (features) with identifiable labels but lacks the “answer” or outcome value (target label) that a machine learning model would typically try to predict. For example, a dataset of customer purchase history where each data point includes details like the customer's location, items bought, purchase date, and price. If this data lacks a label indicating whether the customer is likely to make a repeat purchase, it would be considered unlabeled data. Unlabeled data may be used in unsupervised learning algorithms, where the model tried to find patterns and structure within the data without any predefined target labels. BTL data corresponds to this category of transactional data representing un-alerted population sample-as such it is not suited as training data for supervised learning models.

Transformer architecture essentially transform categorical and/or discrete data values into continuous vector representations that the model can learn from, enabling the model to capture semantic relationships between different features. Vector space operations like dot products and projections can then be performed on the vector-represented account-related activity records. Accordingly, one operational aspect of the disclosed systems and processes involve mapping input tabular data space into an embedded data space (e.g., vector space), such that each dense vector corresponds to an account activity record represented, for example, by a row of the input data table.

The conversion of tabular data records into embedded data points involves feature tokenization and vectorization of tabular data records (e.g., by utilizing neural networks) to capture inherent relationships among different data features and transform the expansive tabular data domain into a compact dense vector space. In accordance with an embodiment, an embedded data point corresponding to a dense vector in vector space may corresponds to a user account activity record.

In one implementation, a feature tokenizer and transformer model may be adapted for implementing the tabular data embedding process. As discussed above, tabular data embedding refers to the process of transforming structured data (like a table) into a lower-dimensional (feature) vector representation, capturing the relationships between features within each row. A “feature vector” is a list of numerical values representing the key characteristics or features of an object, such as a raw tabular data record, as a form that expresses the important attributes of the data as numbers in a single vector. Accordingly, with regards to tabular data rows representing a data sample and columns different features associated with the data sample, a feature vector is a list of numerical values representing the key characteristics or features of an object (in case of tabular data each object could be a row representing a specific user/account sample). This format encompasses inherent characteristics that may be leveraged by downstream machine learning models. For example, in the resulting embedded data space, similar data points (i.e., data points corresponding to similar account records in the input data table) are closely aligned and dissimilar data points are distanced in (feature) vector space.

In accordance with one embodiment, AML risk data pipeline may be implemented based on use-case adaptation of the label expansion process using FT-Transform models further augmented with a graph-based label propagation for optimizing their application in AML-based risk detection modelling from unlabeled tabular transaction data). One feature of this process involves novel semi-supervised learning technique for generating robust labels for unlabeled data points, which improves utility of such data for training risk models for AML detection. The implementation involves modifying the raw unlabeled dataset with a small population of labeled data points (e.g., a reference dataset), and adapting a FT-Transform process for mapping the modified raw data (which includes the reference set) into an optimized embedded data space. This referenced data may be included in the tabulated dataset prior to embedding to seed the label propagation process. Accordingly, the methodology leverages tabular embeddings via FT-transformer model, to construct embeddings from the original tabular data format. In one embodiment a graph-based inference method based on cosine similarity may then be used for automated generation of target label values via label propagation from a limited amount of existing labeled data. This innovative blend enhances the human-in-the-loop labeling process and may be used to identify patterns and insight that may have been missed by rule-based risk identification models.

As described above, a one operational aspect of the disclosed systems and processes involve the construction of tabular embeddings adapted for optimizing the embedded data space for the specific tabular data type. Following this operation, one or more pre-trained embeddings (generated from the tabulated reference and/or truth data) may be used as a starting point for a label expansion process based on label propagation. Label propagation is a semi-supervised learning technique that leverages these embeddings to spread labels from a small set of labeled data points to a larger set of unlabeled data points based on their proximity to the labeled data points in the vector space. In accordance with one embodiment of the present disclosure, following the embedding of the tabulated data set in an embedded domain (e.g., feature vector space) a programmatic step-wise incremental propagation of labels to nearest data points may be performed on the embedded data set for propagating the labels from a small number of labeled data (e/g/. a truth reference set) to the rest of the dataset until the propagation process converges (e.g., all the data samples in the embedded space are labeled). Accordingly, in one implementation the label assignment may be inferenced/predicted based on overall similarity between features of an unlabeled embedded data point and closest labeled data point in the embedded space. Accordingly, one exemplary implementation involves determining labels for each of the plurality of unlabeled embedded data points based on a degree of proximity (overall feature similarity) to one or more nearest labeled data point in the vector/embedded space. The label assignment may then be carried out in an iterative manner starting from the pre-trained labeled data points associated with reference data point) until the propagation process converges (e.g., all the data samples in the embedded space are labeled).

Traditionally, accuracy has been widely used as a stopping criterion in deep learning tasks, offering a simple and intuitive way to gauge model performance. A high accuracy model indicates very few incorrect predictions. However, this doesn't consider the business cost of those incorrect predictions, which is very important for the AML investigation. The most common stopping criteria for optimizing a machine learning model is “early stopping,” which means halting the training process when the model's performance on a validation set starts to deteriorate, indicating that it is overfitting to the training data and not generalizing well to new data; this point is considered the optimal stopping point where the best balance between model complexity and accuracy is achieved.

This may be specifically adapted for the use case scenario involving risk flagged and non-issue labeled set of reference data as it pertains to AML identification of P2P transaction records. As in the aforementioned use case the non-issue class significantly outnumbers the SAR filed class, simply using accuracy can be misleading without considering the true risk coverage. To address this issue, one implementation option utilizes AUROC as a metric to make a decision on stopping criteria. In tabular data embedding, “AUROC” stands for “Area Under the Receiver Operating Characteristic curve,” which is a metric used to evaluate the performance of a binary classification model by measuring how well it can distinguish between positive and negative classes across different classification thresholds; essentially, a higher AUROC value indicates a better ability to accurately classify data points within a tabular dataset where features have been embedded into a lower dimensional space. Accordingly, usage of AUROC may improve calibration of the trade-off between sensitivity and specificity and offer a more comprehensive assessment of the model's predictive ability, and further enhances the quality of embeddings extracted from the tabular model.

Accordingly, one aspect of the described solution leverages the properties of the optimized embedded data space (e.g., a notion of proximity of high-risk (vector) data point to each other in the embedded space relative to those representing low risk accounts), to facilitate a label expansion scheme by propagating existing labels, starting from the reference data (e.g., pre-verified accounts), to most similar (or nearest neighboring) accounts which in embedded space, generated as described above, corresponds to a set of nearest data points (e.g. neighboring accounts) in the embedded space, (e.g., one hop over). This propagation to closest neighboring vector in embedded space is then repeated multiple times until all of the embedded space is labeled. to facilitate label expansion by propagation. In some embodiments, risk scores maybe added and riskiest account are sent to a human reviewer for a second review round. A similarity score based on comparison with one or more neighboring data points in the embedded data space (e.g., feature vector space) may be used to Propagate labels between similar account using label expansion.

According to one embodiment a system and method based on adapted implementation of tabular embedding and label propagation may be used to rank data samples from a BTL data domain using a quality score computed based on labeling consistency with neighboring data points in the embedded space. Based on the generated ranking, a targeted sample space may then be compiled from the un-alerted data pool for training a AML risk identification model.

In some embodiments, label quality metric may be computed for labels provided by a human annotator (or multiple annotators) by calculating a degree of consistency (consistency score) with neighboring data points. Data points associated with low quality labels (e.g., a below-threshold) low consistency score may be sent back to annotator for further review and correction.

### BRIEF DESCRIPTION OF THE DRAWINGS

FIG. 1A illustrates an adapted implantation of FT-Transformer process for embedding tabulated data, according to an example embodiment.

FIG. 1B provides an exemplary conceptual illustration of label expansion using label propagation in embedded data space with one or more pre-trained embeddings generated from limited reference/truth data, according to an example embodiment.

FIG. 1C illustrates a hardware implementation system for executing an adapted FT-transformer process for embedding tabulated data and a label expansion scheme, according to an example embodiment.

FIG. 2 illustrates an operational flow diagram for a label expansion process to facilitate usage of BTL data for AML risk training data models, according to an example embodiment.

FIG. 3 illustrates an enhanced human-in-the-loop fully supervised training model using label expansion, according to an example embodiment.

FIG. 4 illustrates a flow diagram for the enhanced human-in-the-loop fully supervised model, according to an example embodiment.

FIG. 5 illustrates label quality quantification process based on a consistency score, according to an example embodiment.

FIG. 6 illustrates an operational flow diagram for the label quality quantification process, according to an example embodiment.

FIG. 7 illustrate experimental results associated with a performance aspect of the exemplary system and method.

FIG. 8 illustrates a block diagram of an exemplary system according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

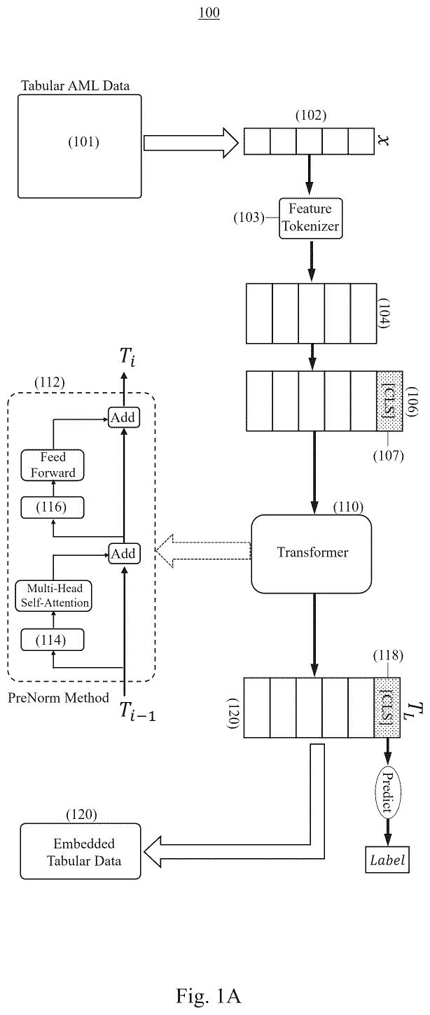

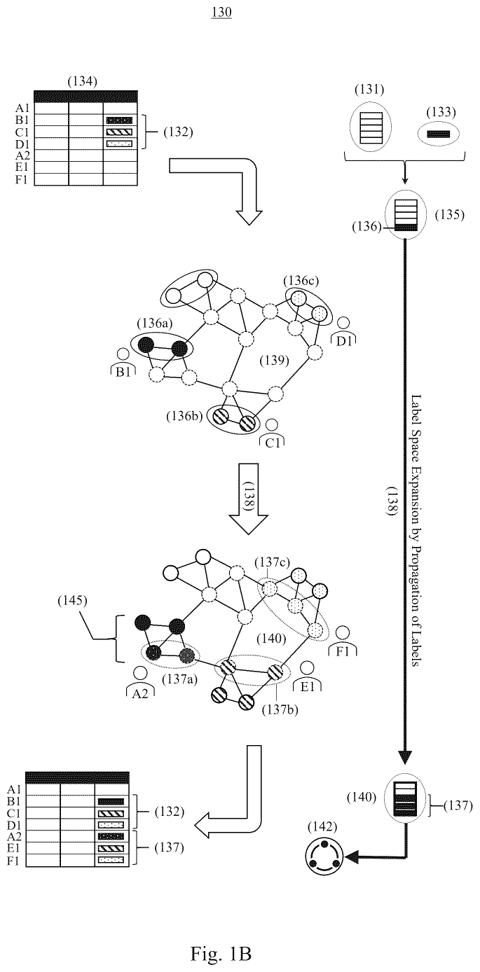

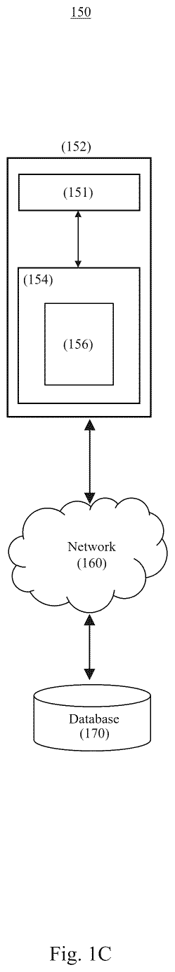

FIG. 1A illustrates an adapted implantation of a feature tokenizer and transformer (FT-Transformer) process for embedding tabulated data, according to an example embodiment. Exemplary embodiment 100 adapts a feature-tokenizer transformer (FT-Transformer) model to processing of AML tabular data 101 as shown in FIG. 1. The FT-Transformer comprises two main components, the first component corresponds to the feature tokenizer 103 which convert all the data features associated with tabulated records 101, (e.g., categorical, descriptive and numerical features), into a set of tokens 104. In some embodiments a one-hot-encoding layer and a dense layer may be used to tokenize categorical and numerical values, respectively. The feature tokenizer 103 may take in data features 102 extracted from tabular AML data 101 and output tokenized feature sequence 104 to be processed by the second component corresponding to Transformer 110. Referring back to exemplary implementation 100, prior to providing the tokenized feature sequence 104 to the transformer 110, a classify or classification (CLS) token 107 may be appended to the tokenized sequence 104 to yield a second tokenized sequence 106. These tokens (e.g., dataset 106) may then serve as inputs for the transformer component 110. The CLS token 107 represents a special token for allowing the transformer model to aggregate information from all the features and generate a single, global representation used for prediction. The CLS token 107 essentially summarizes the entire input data 104 for classification tasks.

In implementation 100, unlike transformer layers used in natural language tasks, the CLS token 107 is attached to the beginning of the input sequence 104 to generate an input sequence 106. The input sequence 106 undergoes processing through each layer of the transformer module/process 110. Referring back to example 100, the feature tokenizer component 103 transforms all features 102 (e.g., categorical, descriptive and numerical data features) to a set of tokens 104, a CLS token 107 is appended to tokenized sequence 104 to yield input sequence 106. Next a stack of transformer layer is applied to the tokens in the sequence 106 such that every transformer layer operates on the feature level of one object. With reference to example 100, L transformer layers may be applied by the transformer 110 to the tokens in the input sequence 106 to generate an embedded tokenized sequence T_{L} represented by embedded dataset 120 in FIG. 1.

The transformer 110, as illustrated in the exemplary implementation 100, integrates a pre-normalization scheme, as shown by the transformer block illustration 112, to simplify optimization and enhance the efficiency of the tabular embedding process.

In the context of an FT-Transformer, layer normalization is a technique where the inputs to each layer of the neural network are normalized by calculating the mean and standard deviation across all features within a single sample, ensuring that the data entering each layer has a consistent distribution, which helps stabilize training and improve the model's performance. As shown in the exemplary transformer block illustration 112, the transformer process/module 110, in line with its adaptation for embedding of tabular data (as provided in example 100), applies layer normalization operations 114 and 116 before the self-attention layer (which is a matrix of equations that are typically executed in parallel and calculate how each element in the data relates to the other data elements) and feedforward layer (which is a neural network that extracts higher level features from the input) within each transformer block 112. In effect, in accordance with embodiments of the present disclosure, a layer normalization operation is applied to the input features and the normalized output is further processed by various transformer layers (e.g., attention and feedforward layers). This improves training stability and performance by mitigating vanishing and/or exploding gradient issues, resulting in easier optimization and good performance. In the output embedded dataset 120, the final representation of the CLS token 118 may then be used for prediction of a target label value. The final embedded sequence 120, generated at an output of a transformer process 110, may then be used as input into a label expansion process as further illustrated in FIG. 1B.

FIG. 1B provides a conceptual illustration 130 of an exemplary label expansion process using label propagation in embedded data space with limited ground truth, according to an example embodiment. With reference to example 130, an initially unlabeled dataset 131 may be combined with one or more ground truth or reference data 133 to constitute an embedded input sequence 135 (with limited pretrained seed data values 136). In example 130, referenced data 133 may correspond to tabular data records 132 that are associated with a target label value (e.g., rows B1, C1 and D1 of data table 134). During a label expansion process 138, one or more pre-trained embeddings 136 (associated with reference tabulated data records 132 with a target label value) may be used as a starting point for a label propagation process based on a semi-supervised label propagation scheme. The label propagation scheme 138 is operative to expand input sequence 135 into dataset 140 with an expanded label space 137. Once all the data points in the input sequence 135 have been labeled, the data may be used as input for training a fully supervised learning mode1 142. The transformation of partially labeled embedded data space 139, including one or more sets of prelabeled reference data (e.g., 136a-136c), into an embedded data space 140 with label expansion in embedded data space may form essential parts of a data pipeline for preparing raw tabular data for training and evaluation of machine learning models.

In some embodiments, the label propagation operation 138 may be directed by a graph-based inference method, as shown in example 130. A graph structure 139 (provided for purpose of illustration) may be generated from input data table 134 following an adapted FT-Transformer process to implement feature embeddings of the tabular records associated with data table 134. As shown in example 130, input data table 134 may be represented as graph 139 with embedded data points represented as nodes in the graph (e.g., a single tabulated record represented by a row of table 134) and edges created based on pairwise similarity between data points. The graph 139 representing embedded space may correspond to a visual representation of the embedded data sequence 135 generated from the input tabular data 134 based on adapted application of FT-Transformer process. Graph 139 may comprise pre-trained embeddings (e.g., seed data values) generated from limited truth or reference data 133 that have been pre-verified as high risk (e.g., 136a) and/or low risk (e.g., 136b). In some embodiments there may be other risk level gradation beyond a high and/or a low risk designation based on specific application (e.g., 136c). Accordingly, seed data values corresponding to initial labeled data points (e.g., 136a-136c) may be used to seed the label propagation process 138 across a constructed graph 139, allowing label values to be inferred for one or more unlabeled data points based on their connections to labeled data points (e.g., seed data points 136a-136c). Accordingly, mapping function 138 may correspond to a graph-based semi-supervised learning process for implementing a label space expansion. With reference to example 130, an exemplary visual representation of the embedded data domain with an expanded label space (e.g., including 137a, 137b and 137 c) is illustrated by graph 140.

In accordance with one embodiment, a similarity measure between two nodes may be determined by a similarity metric like Euclidean distance or cosine similarity, which considers all features of the data points. label propagation looks at the labels of its nearest neighbors in the graph, which takes into account the overall similarity across all features, not just the closest single feature value. Closer data points tend to have similar class labels or target values.

Referring back to example 130, additional labels 137a-137c may be created for previously unlabeled data points (e.g., tabular data records A2, E1, and F1) based on similarity determination with, and subsequent label propagation from, existing labeled data points B1, C1, and D1 corresponding to target label values 136a-136c. Based on proximity with known fraud transactions represented as embedded data points 136a (e.g., corresponding to user B1), embedded data points 137a, corresponding to user A2, may be similarly characterized to form a cluster 145 associated with a high risk of fraud.

One aspect of the described process may be facilitated by the exemplary system implementation 150, illustrated in FIG. 1C. Example 150 of FIG. 1C, illustrates an exemplary representation of a server, network and a database.

The server 152 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 152 may include a processor 151, a memory 154, and an application 156. The processor 151 may be a processor, a microprocessor, or other processor, and the server 152 may include one or more of these processors. The processor 151 may include processing circuitry, which may contain additional components, including additional processors, memories, error and parity checkers, data encoders, anti-collision algorithms, controllers, command decoders, security primitives and tamper-proofing hardware, as necessary to perform the functions described herein.

The processor 151 may be coupled to the memory 154. The memory 154 may be a read-only memory, write-once read-multiple memory or read/write memory, e.g., RAM, ROM, and EEPROM, and the server 152 may include one or more of these memories. A read-only memory may be factory programmable as read-only or one-time programmable. One-time programmability provides the opportunity to write once then read many times. A write-once read-multiple memory may be programmed at a point in time after the memory has left the factory. Once the memory is programmed, it may not be rewritten, but it may be read many times. A read/write memory may be programmed and re-programed many times after leaving the factory. It may also be read many times. The memory 154 may be configured to store one or more software applications, such as the application 156, and other data, such as user's private data and financial account information.

The application 156 may comprise one or more software applications comprising instructions for execution on the server 152. In some examples, the server 152 may execute one or more applications, such as software applications, that enable, for example, network communications with one or more components of the system 150, transmit and/or receive data, and perform the functions described herein. Upon execution by the processor 151, the application 156 may provide the functions described in this specification, specifically to execute and perform the steps and functions in the process flows described herein. Such processes may be implemented in software, such as software modules, for execution by computers or other machines. The application 156 may provide GUIs through which a user may view and interact with other components and devices within the system 150. The GUIs may be formatted, for example, as web pages in HyperText Markup Language (HTML), Extensible Markup Language (XML) or in any other suitable form for presentation on a display device depending upon applications used by users to interact with the system 150.

The server 152 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 152 that can be available and supported by the server 152, such as a touch-screen, keyboard, mouse, cursor-control device, touch-screen, microphone, digital camera, video recorder or camcorder. These devices may be used to enter information and interact with the software and other devices described herein.

System 150 may include one or more networks 160. In some examples, the network 160 may be one or more of a wireless network, a wired network or any combination of wireless network and wired network and may be configured to connect the user devices (e.g., mobile device and/or computing device), the server 152 and the database 170. For example, the network 160 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 160 may include, without limitation, telephone lines, fiber optics, IEEE Ethernet 902.3, a wide area network, a wireless personal area network, a LAN, or a global network such as the Internet. In addition, the network 160 may support an Internet network, a wireless communication network, a cellular network, or the like, or any combination thereof. The network 160 may further include one network, or any number of the exemplary types of networks mentioned above, operating as a stand-alone network or in cooperation with each other. The network 160 may utilize one or more protocols of one or more network elements to which they are communicatively coupled. The network 160 may translate to or from other protocols to one or more protocols of network devices. Although the network 160 is depicted as a single network, it should be appreciated that according to one or more examples, the network 160 may comprise a plurality of interconnected networks, such as, for example, the Internet, a service provider's network, a cable television network, corporate networks, such as credit card association networks, and home networks. The network 160 may further comprise, or be configured to create, one or more front channels, which may be publicly accessible and through which communications may be observable, and one or more secured back channels, which may not be publicly accessible and through which communications may not be observable.

System 150 may include a database 170. The database 170 may be one or more databases configured to store data, including without limitation, private data of users, financial accounts of users, identities of users, transactions of users, and certified and uncertified documents. The database 170 may comprise a relational database, a non-relational database, or other database implementations, and any combination thereof, including a plurality of relational databases and non-relational databases. In some examples, the database 170 may comprise a desktop database, a mobile database, or an in-memory database. Further, the database 170 may be hosted internally by the server 152 or may be hosted externally of the server 152, such as by a server, by a cloud-based platform, or in any storage device that is in data communication with the server 152.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 101, the user device 110, the server 152, the network 160, and the database 170 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally, or alternatively, a storage arrangement can be provided separately from the computer-accessible medium, which can provide the instructions to the processing arrangement so as to configure the processing arrangement to execute certain exemplary procedures, processes, and methods, as described herein above, for example.

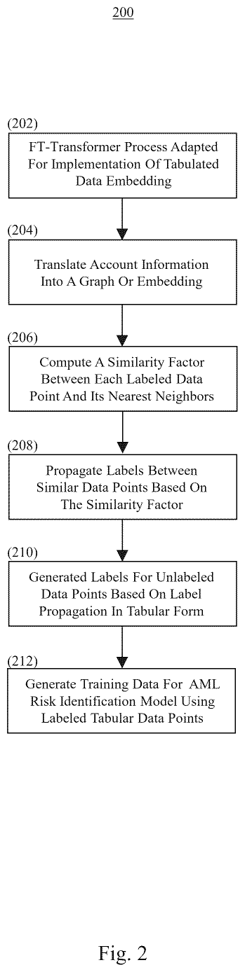

FIG. 2 illustrates an exemplary operational flow diagram 200 directed to an incorporation of tabular data embedding and label propagation processes for expanding an AML training dataset. Referring to example 200, illustrated in FIG. 2, step 202 corresponds to an implementation of a mapping function using feature tokenizer and a transformer function for transforming one or more tabulated datasets into a feature vector space. At step 204 Account information is translated into a graph of embedded data points such that each account transaction record, comprising various data features and attributes, is converted into a feature vector that may be represented as an embedded data point on a graph. At step 206 a similarity factor is computed between each labeled data point in the embedded space and its neighboring data points. Nearest neighboring data points are characterized with highest degree of similarity.

At step 208 seed data values act as the starting point for label propagation, where the labels of these pre-labeled points are propagated through the graph to neighboring unlabeled nodes based on their similarity or connection strength. This results in an expansion of the label space to encompass previously unlabeled data points corresponding to un-alerted/unlabeled account records. As described earlier, these data points may correspond to below-the-line (BTL) or unalerted population of collected data record associated with various transactional activities conducted with one or more specific user accounts. At step 210 labels are generated for unlabeled tabulated data records based on the label assignment during the label propagation phase between proximate data points in the embedded data space.

Following the label expansion process, at step 212 the dataset with an expanded labeling domain, corresponding to labeled tabular data points, may be used as training data for a risk identification data model. In some embodiments, labeling characteristics may be associated with AML risk identification.

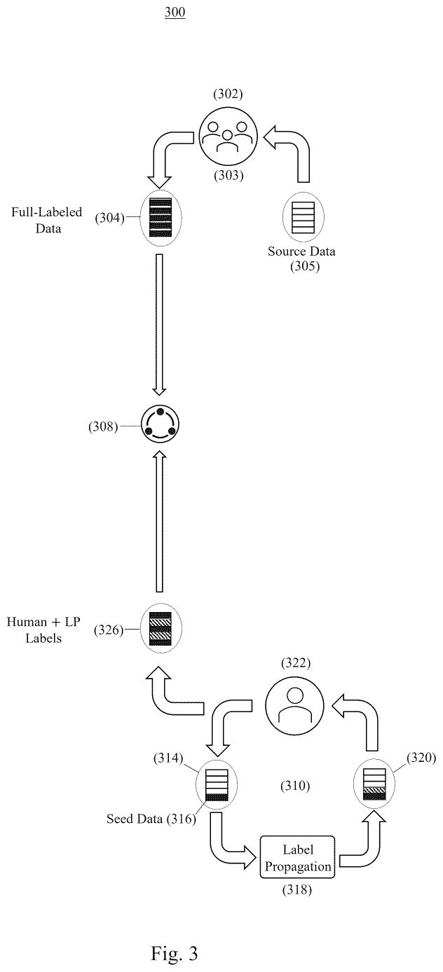

FIG. 3 illustrates an implementation of an enhanced human-in-the-loop fully supervised labeling process using the adapted tabular data embedding process and automated label propagation scheme as described above. FIG. 3 also illustrate a conventional data labeling process 302 using human annotators 303 to generate a fully labeled dataset 304 from a source dataset 305. The fully-labeled dataset 304 may be used to facilitate a supervised training model (e.g., human-in-the-loop fully supervised model 308).

Referring back to example 300, the enhanced human-in-the-loop labeling process 310 may be implemented using label propagation in optimized embedded data space generated from a tabular dataset. The source tabular dataset 305, modified to include one or more reference data values (e.g., data samples with a target label value), is mapped onto an embedded and/or vectorized dataset 314. The embedded data include one or more seed values 316 corresponding to the one or more reference data values in the source tabular dataset. A label propagation process 318 executed on the embedded dataset 314 facilitates automated assignment of labels to unlabeled data points resulting in an expansion of labeled data point as shown by partially-labeled dataset 320. The partially-labeled data may then be used by a human annotator 322, (associated with less effort relative to manual annotation 303 in conventional labeling process 302) for selection of representative samples for next batch of label propagations. The enhanced human-in-the-loop labeling process 310 is operative to generate a fully labeled dataset 326 via a semi-supervised training process rather than a fully-supervised training process 303 associated with conventional data labeling process 302. The fully labeled dataset 326 may then be used as training input for the fully-supervised model 308. Label propagation reduces human-in-the-loop labeling cost through enhancing the ML feedback loop. The selection from automated labeling may result in higher quality labels that can significantly impacts the training performance.

In one embodiments, the exemplary process illustrated in FIG. 3 may generate rough classification to assist fine labeling with viable experiment cost. The process may further reduce total labeling cost for downstream modelling by optimizing the selection of data samples to label.

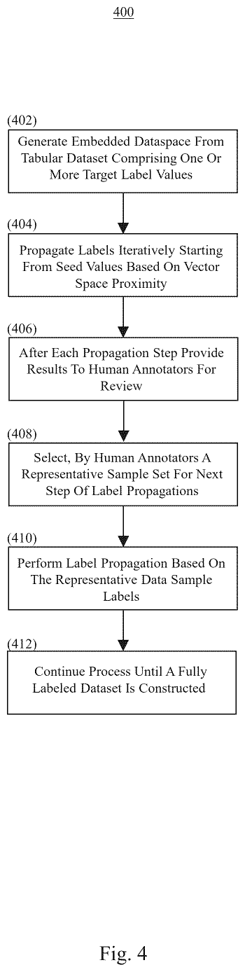

FIG. 4 illustrate an exemplary flow diagram 400 directed to an exemplary process for assisting human labeling process through stepwise incremental propagation to select the next batch of most informative samples for a human(s) annotations. Referring to example 400 in FIG. 4, at step 402 one or more tabular datasets comprising one or more data records including a target label value is processed via an adapted FT-Transformer configuration to map the tabulated data records into an embedded data space (e.g., a vector space) with each tabulated data record being represented as a feature vector and/or an embedded data point in the transformed data space. An exemplary embodiments of this mapping process for tabular data was described in connection with FIG. 1A showing transformation of a dataset 102 comprising numerical/categorical/textual data features associated with sample data records (e.g., raw user account activity records) into tokenized and transformed data sequence 120 in embedded data space. As described above, the tabular data, comprising mostly of unlabeled data records, may include one or more reference data records with a target label values provided, for example, by a human annotator. The reference data records may act as seed values for a downstream label propagation process.

Referring back to the exemplary operation flow diagram 400, following the tabular data transformation at setup 402, at step 404 labels associated with the seed data values may be propagated, based on vector space proximity, to its nearest neighbor. Label propagation, in accordance with one embodiment as illustrated, for example, in FIG. 1B, may proceed via a stepwise incremental propagation to the rest of the unlabeled data points in the embedded space. However, in the exemplary operation flow 400 (corresponding to human-in-the-loop labeling process 310 of FIG. 3), the result of each propagation step may be provided to a human annotators for review, as shown by step 406. The human annotator may select seed data values, based on quality, for the next step of the propagation process. This selection of seed data points can significantly impact the performance of the semi-supervised learning model, as the quality of the graph and the distribution of seed nodes influences how well labels are propagated.

Accordingly, at step 408 one or more human annotators may select a representative sample set of labeled data points for the next step of label propagation. At step 410, the next step of the label propagation process proceeds based on the representative data sample labels selected by the one or more human annotators in step 408. At step 412 the process may continue in an iterative fashion until a fully labeled dataset is constructed.

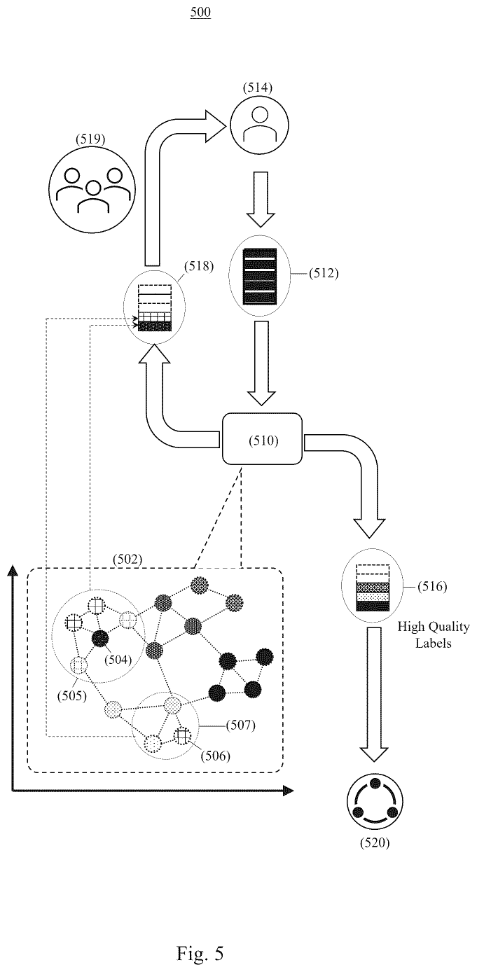

FIG. 5 illustrates label quality quantification process based on a consistency score, according to an example embodiment. As described above, the quality of human labels directly impacts the training performance and accuracy of a machine learning model. In accordance with an embodiment of the present disclosure a label quality metric may be computed for each labeled data point based on neighborhood similarity with proximate embedded data points-the embedded data point may then be ranked by the quality score and a targeted sample space of data points with highest quality labels may be generated from un-alerted/un-labeled data pool based on the generated ranking.

In accordance with one embodiment, label propagation may be supplemented with a label quality assurance and automated outlier filtering feature based on a computation of neighborhood similarity factor for the labeled data points. Accordingly, one embodiment of the present disclosure involves a label quality quantification process based on computation of a consistency score which quantifies a degree of local labeling consistency with a set of nearest neighboring data points. Consistency score measures how consistent the label of a specific data sample is with its nearest neighbors. In accordance with one embodiment, consistency scores may be used to provide a label quality ranking and outlier filtering based on neighborhood similarity.

In one embodiment, label quality quantification on a basis of a consistency may be applied for building a benchmark dataset for label quality assessment which uses varying degrees of consensus among distinct labelers (e.g., raw dataset with multiple annotators) as a surrogate for label quality determination. In another embodiment, label quality determination may ensure that human labels meet specified quality requirements based on the consistency score. Accordingly, one or more consistency scores are used to improve the labeling quality by initiating the re-sending of data point, with a consistency score blow a predetermined threshold, back to the human labeler. In this way labelled data points with high confidence labels may be used to guide the label propagation process more accurately.

Referring now to example 500, embedded data space representation 502, associated with the larger data labeling implementation 500, may be associated with a lack of label assignment consistency for data points 504 and 506 within corresponding local group 505 and 507. Accordingly, a label quality filter 510 is devised to measure how consistent the label of a specific embedded data sample is with its nearest neighbors.

Referring back to FIG. 5, label quality filter 510, as implemented in example 500, receives a dataset 512 including labels assigned by a human annotator 514. The label quality filter 510 computes a labelling consistency-based quality score based on similarity with proximate data points and generates a dataset 516 including high quality labels (e.g., labels with an above-threshold consistency score) and a dataset 518 including low-quality labels (e.g., labels with an below-threshold consistency score). In accordance with exemplary operations illustrated in embodiment 500, dataset 516, including high quality labels, may be provided as input into a supervised learning model 520. The label quality filter 510 may be further configured to compile a dataset 518, including low quality labels, and send dataset 518, including data points with low quality labels, back to the human annotators 514 and/or a set of reviewing annotators 519 to improve and/or correct the labeling defects identified by the quality filter 510. The disclosed systems and processes utilizing a label quality filtering process, based on the described application of label propagation implemented in a tabulated data embedding/vector space, not only increases efficiency of the labeling process thus lowering labeling costs, but also improves labelling quality performance based on localized determination of labeling consistency.

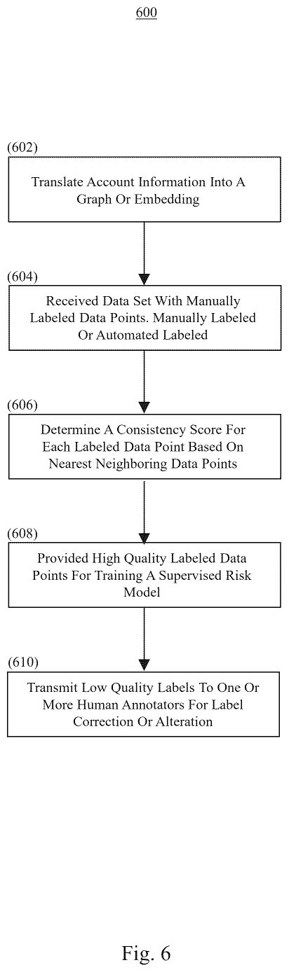

FIG. 6 represent a flow diagram using tabular data embedding and label propagation process for label quality quantification process based on a consistency score. Referring to example 600, illustrated in FIG. 6, at step 602 a mapping function using a feature tokenizer and a transformer function is used for transforming tabulated account information into a graph of embedded data points such that each account transaction record comprising various feature attributes is converted into a feature vector represented as an embedded data point in a feature vector space.

At step 604 a dataset including one or more data records, with target label values assigned by a human annotator, is received by a label quality filter running as part of an enhanced human-in-the loop automated labeling process. In accordance to some embodiments, a similarity factor may be computed between each labeled data point in the embedded space and its neighboring data points, such that nearest neighboring data points are associated with highest degree of similarity. Accordingly, at step 606 a labelling consistency-based quality score, based on similarity with proximate data points, may be computed by the label quality filter. At step 608 a first dataset including high quality labels (e.g., labels with an above-threshold consistency score) may be constructed by the label quality filter and provided as inputs into a supervised learning model. At step 610 the label quality filter may generate a second dataset including low quality labels (e.g., labels with below-threshold consistency score) and transmit the low quality labels, included in the second dataset, back to one or more human annotators for a quality check.

Using tabular data embedding process, experimental results based on rigorous clustering metrics, are generated in support of the assumption that unlabeled and/or below-the-line (BTL) domain share a notable close relationship with above-the-line (ATL) data samples labeled as non-issue. In an experimental training process, BTL data was deliberately excluded to ensure that the model had not been exposed to BTL data prior to inference. This approach allows the usage of the trained model to evaluate the degree of distinctness or overlap between BTL and SAR-filed data, as well as between BTL and Non-issue data. In one experimental trial, the FT-transformer model was trained with 1,633 SAR-filed data and 10,400 “non-issue data from the training set. The experiment incorporated 73 numerical features, as utilized in the P2P model. Notably, 7 of these features only had two distinct values: 1 and 0. To enhance the FT-transformer's performance, these features were treated as categorical features. The tokenizer components of the FT-transformer then tokenized these 7 categorical features along with the remaining 66 numerical features. Within the transformer components, the experiment integrated 3 transformer blocks, each equipped with 8 heads and an embedding size of 32. The output was then passed through a layer normalization layer to yield the final 32-dimensional embedding. During the training process, a batch size of 4094, a learning rate of 0.0001, and the cross-entropy loss function were used.

Experimental results generated using use case data reveal the potential benefits of label propagation on risk identification enhancements. In one embodiment, a 13 rule risk identification process acting on transaction card data was replaced with a ML model to predict suspicious transactional activity (e.g., money laundering related transactions)—the labels were assigned three categories corresponding to suspicious ATL, non-issue ATL and BTL data points. The initial sample space contained 99% unlabeled data. 100 targeted samples were selected based on the overlap of embedding and label propagation. The model output predicted 8% suspicious activity risk (e.g., AML risk) within the BTL data point using the targeted samples, which demonstrates an improvement from the 2% suspicious activity risk identification within BTL data points using random sampling.

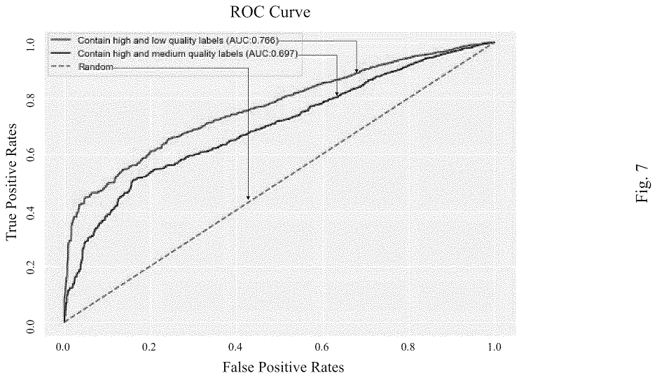

Experimental results showing efficacy of using a consistency score in filtering medium-quality labels from high-quality ones and further filtering label outliers with low quality are illustrated in FIG. 7.

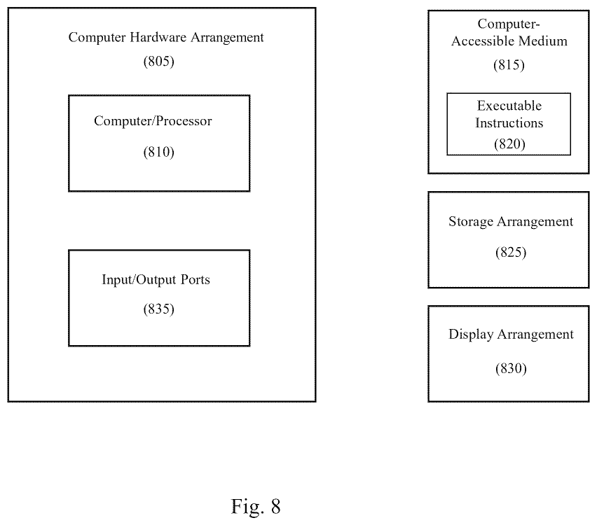

FIG. 8 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 805) may be configured for computing a trajectory of the contactless card within an optical field of view generated by a camera unit of user device and projecting a final placement of the contactless against a reader unit of the user device at a point at which the camera feed goes dark). Such processing and/or computing arrangement 805 can be, for example entirely or a part of, or include, but not limited to, a computer and/or processor 810 that can include, for example one or more microprocessors, and use instructions stored on a computer-accessible medium (e.g., RAM, ROM, hard drive, or other storage device).

As shown in FIG. 8, for example a computer-accessible medium 815 (e.g., as described herein above, a storage device such as a hard disk, floppy disk, memory stick, CD-ROM, RAM, ROM, etc., or a collection thereof) can be provided (e.g., in communication with the processing arrangement 805). The computer-accessible medium 815 can contain executable instructions 820 thereon. In addition, or alternatively, a storage arrangement 825 can be provided separately from the computer-accessible medium 815, which can provide the instructions to the processing arrangement 805 so as to configure the processing arrangement to execute the exemplary procedures, processes, and methods, as described herein above, for example.

Further, the exemplary processing arrangement 805 can be provided with or include an input and/or output ports 835, which can include, for example a wired network, a wireless network, the internet, an intranet, a data collection probe, a sensor, etc. As shown in FIG. 8, the exemplary processing arrangement 805 can be in communication with an exemplary display arrangement 830, which, according to certain exemplary embodiments of the present disclosure, can be a touch-screen configured for inputting information to the processing arrangement in addition to outputting information from the processing arrangement, for example. Further, the exemplary display arrangement 830 and/or a storage arrangement 825 can be used to display and/or store data in a user-accessible format and/or user-readable format.

Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for training a risk model with unlabeled transactional data, the method comprising:
transforming, by a processor, an input tabular dataset comprising a plurality of unlabeled data points and one or more labeled data points into a plurality of embedded data points, wherein each tabular data sample in the input tabular dataset comprises one or more features, wherein the transforming operation comprises:
tokenizing the one or more features for each of the plurality of tabular data samples to generate a plurality of feature vectors representing the plurality of tabular data samples in an embedded data space,
attaching a classification (CLS) token to a beginning of each feature vector, to generate a plurality of input sequences representing each embedded data sample,
normalizing each of the plurality of input sequences across all features within the sequence, and
processing each of a plurality of normalized input sequences through one or more transformation layers to generate an optimized embedding space comprising a plurality of multi-dimensional embeddings;
identifying, by the processor, one or more first embedded data points comprising a target label in the embedded data space, wherein the one or more first embedded data points correspond to the one or more labeled data points in the input tabular dataset; and
generating, by the processor, labels for each of the plurality of unlabeled embedded data points, based on a degree of proximity to one or more nearest labeled data point starting from the first embedded data points, in the optimized embedding space.

2. The method of claim 1, wherein the input tabular dataset is augmented with a reference dataset comprising the one or more labeled data points prior to the transformation process.

3. The method of claim 1, wherein a performance metric for determining an optimal quality of the plurality of multi-dimensional embeddings generated from the tabular dataset corresponds to an area under the receiver operating characteristic curve (AUROC).

4. The method of claim 1, wherein the degree of proximity to one or more nearest labeled data point corresponds to an overall feature similarity with a corresponding one or more labeled data point in the optimized embedding space.

5. The method of claim 4, wherein the overall feature similarity with the corresponding one or more labeled data point in the optimized embedding space corresponds to a measure of cosine similarity between the corresponding feature vectors in the optimized embedding space.

6. The method of claim 5, wherein similarly labeled embedded data point are associated with a greater degree of cosine similarity in the optimized embedding space.

7. The method of claim 1, wherein the generation of labels for each of the plurality of unlabeled data points in the optimized embedding space is based on graph-based inference for incremental assignment of labels to one or more neighboring unlabeled data points, starting from one or more reference labeled data points and propagating across the plurality of unlabeled data points associated with the input tabular dataset.

8. The method of claim 1, wherein the one or more features of a tabular data points comprise one or more data types corresponding to one or more text, numerical and categorical types, wherein the one or more features are tokenized and mapped onto an embedded data space.

9. The method of claim 1, wherein the plurality of unlabeled data points corresponds to un-alerted transactional record samples and the one or more labeled data points comprises one or more sample transactional records pre-verified and manually labeled with a risk level associated with anti-money laundering (AML) activities.

10. The method of claim 9, wherein the risk level indicates one of a low-risk, a high risk and average risk of suspicious activity associated with money laundering operations.

11. The method of claim 1, further comprising:
assigning, by the processor, risk scores to the labeled embedded data points in the optimized embedding space; and
generating a targeted data sample population, based on the assigned risk scores, for training an anti-money laundering (AML) data model associated with detection of suspicious activity directed at money laundering operations.

12. The method of 11, wherein one or more high-risk data points, corresponding to risk scores exceeding a first pre-determined threshold are sent to a human reviewer for a second round of review.

13. The method of claim 1, further comprising utilizing the input tabular dataset as a starting point for Machine Learning Analysis for Data Incompleteness (MADI ML) modeling.

14. A non-transitory computer readable medium containing executable instructions, wherein, when executed by a processor, the instructions cause the processor to perform procedures comprising:
transforming an input tabular dataset comprising a plurality of unlabeled data points and one or more labeled data points, into a plurality of embedded data points, wherein each data sample in the input tabular dataset comprises one or more features, wherein the transforming operation comprises:
tokenizing the one or more features for each of the plurality of tabular data samples to generate a plurality of feature vectors representing the plurality of tabular data samples in an embedded data space;
attaching a classification (CLS) token to a beginning of each feature vector, to generate a plurality of input sequences representing each embedded data sample;
normalizing each of the plurality of input sequences across all features within the input sequence;
processing each of a plurality of normalized input sequences through one or more transformation layers to generate an optimized embedding space comprising a plurality of multi-dimensional embeddings;
identifying one or more first embedded data points comprising a target label in the embedded data space, wherein the one or more first embedded data points correspond to the one or more labeled data points in the input tabular dataset; and
generating labels for each of the plurality of unlabeled embedded data points based on a degree of proximity to one or more nearest labeled data point starting from the first embedded data points in the optimized embedding space.

15. The non-transitory computer readable medium of claim 14, further comprising:
performing, by the processor, a label quality determination on the optimized embedding space based on one or more consistency scores assigned to one or more labeled embedded data points,
wherein the consistency score measures a level of consistency of a label associated with an embedded data point with its nearest neighboring data point in the optimized embedding space.

16. The non-transitory computer readable medium of claim 15, further comprising performing a human labeling quality assurance based on an automated generation of consistency scores for one or more labeled embedded data points, wherein low quality labels, identified based on consistency score below a pre-determined threshold, are sent back to one or more human labelers for label revision.

17. The non-transitory computer readable medium of claim 16, further comprising performing label quality assessment based on degree of consensus among the one or more human labeler as a measure of label quality.

18. The non-transitory computer readable medium of claim 17, further comprising:
performing a label quality ranking based on the assigned consistency scores, wherein the label quality ranking is used for outlier filtering based on neighborhood similarity; and
generating a benchmark dataset for label quality assessment.

19. The non-transitory computer medium of claim 14, wherein the plurality of unlabeled data points corresponds to un-alerted transactional record samples and the one or more labeled data points comprises one or more sample transactional records pre-verified and manually labeled with a risk level associated with anti-money laundering (AML) activities.

20. A computer hardware arrangement, comprising:
a processor; and
a memory containing executable instructions,
wherein, when executing the instructions, the processor:
transforms an input tabular dataset comprising a plurality of unlabeled data points and one or more labeled data points, into a plurality of embedded data points, wherein each data sample in the input tabular dataset comprises one or more features, wherein the transforming operation comprises:
tokenizing the one or more features for each of the plurality of tabular data samples to generate a plurality of feature vectors representing the plurality of tabular data samples in an embedded data space,
attaching a classification (CLS) token to a beginning of each feature vector, to generate a plurality of input sequences representing each embedded data sample,
normalizing each of the plurality of input sequences across all features within the input sequence, and
processing each of a plurality of normalized input sequences through one or more transformation layers to generate an optimized embedding space comprising a plurality of multi-dimensional embeddings;
identifies one or more first embedded data points comprising a target label in the embedded data space, wherein the one or more first embedded data points correspond to the one or more labeled data points in the input tabular dataset; and
generates labels for each of the plurality of unlabeled embedded data points, based on a degree of proximity to one or more nearest labeled data point starting from the first embedded data points, in the optimized embedding space.
